(19) United States
(12) Patent Application Publication
(10) Pub. No.: US 2007/0162425 A1
(43) Pub. Date: Jul. 12, 2007

(54) System and method for performing advanced cost/benefit analysis of asynchronous operations

(75) Inventors: Anjali Betawadkar-Norwood, Campbell, CA (US); Susanne Englert, San Jose, CA (US); Simon David Harris, Warwick (GB); David Everett Simmen, San Jose, CA (US); Hansjorg Zeller, Los Altos, CA (US)

Correspondence Address: SANDRA M. PARKER;LAW OFFICE OF SANDRA M. PARKER, 329 LA JOLLA AVENUE, LONG BEACH, CA, 90803, US

(73) Assignee: International Business Machines Corporation, Armonk, NY (US)

(21) Appl. No.: 11/327,125

(22) Filed: Jan. 6, 2006

(51) Int. Cl. G06F 17/30

(52) U.S. Cl. 707/2

(57) ABSTRACT

Method, apparatus and computer usable medium tangibly embodying a program of instructions is provided for performing advanced cost/benefit analysis of subplans of a query execution plan, in a computer system having a database software server. Method augments a cost estimation model, obtained from an optimizer of the software server after determination of an optimal query execution plan, with a cost/benefit analysis of operating each subplan of the query execution plan asynchronously. It calculates a subplan elapsed time benefit of making the subplan asynchronous using a set of cost estimates for each subplan operation and knowledge of the execution sequence of the query execution plan operations, all provided by the query optimizer. Set of subplans for asynchronous execution is chosen to form an optimal set of subplans while respecting a resource constraint, for providing a maximal reduction of the total query elapsed time while conserving system resources of the software server.

### BACKGROUND OF THE INVENTION

1. Field of the Invention

The present invention generally relates to database management systems, and, more particularly, to mechanisms within computer-based database management systems for augmenting an existing cost estimation model, obtained from an optimizer of the software server after determination of an optimal query execution plan, with a cost/benefit analysis of operating each subplan of the query execution plan asynchronously.

2. Description of Related Art

The increasing popularity of electronic commerce has prompted many companies to turn to application servers to deploy and manage their applications effectively. Quite commonly, these application servers are configured to interface with a database management system (DBMS) for storage and retrieval of data. This often means that new applications must work with distributed data environments. As a result, application developers frequently find that they have little or no control over which DBMS product is to be used to support their applications or how the database is to be designed. In many cases, developers find out that data critical to their application is spread across multiple DBMSs developed by different software vendors.

A federated server is a piece of software that has the ability to access physically distributed and disparate database management systems (DBMS) residing on different hardware systems and possibly storing data in different formats. It is capable of executing federated queries, which reference objects located in multiple databases in a federated environment. Some examples of a federated server are IBM's DataJoiner product and IBM's WebSphere Information Integrator product.

WebSphere Information Integrator (WebSphere II V8.2) processes federated queries by executing operations on remote data sources of the federated environment sequentially, one at time. A potential performance gain can be realized by accessing remote data sources and performing operations on them in parallel (asynchronously), as the overlapping processing can reduce overall execution time of such queries.

UNION queries involving multiple federated sources provide the most compelling example of the potential advantage of asynchronous processing. One exemplary query which involves two remote sources is:
SELECT * from informix.t1 UNION all SELECT * from sybase.t2

It is desirable to execute both SELECTs in the UNION at the same time, as each of them accesses a different remote data source. Federated joins involving multiple data sources introduce similar opportunities to overlap processing of the inputs to the joins.

Resource-consumption based cost information is gathered by the conventional federated optimizer and is used to compare competing query execution plans to find the one with the lowest total cost. However, this cost information does not reflect the impact to the elapsed time of the query occurring from overlapping or concurrent operations, and so the conventional federated optimizer, by itself, cannot be used to make decisions about the benefit of introducing asynchrony into an execution plan.

Therefore, there is a need to provide a method and system for augmenting an existing cost estimation model, obtained from an optimizer of the software server after determination of an optimal query execution plan, with a cost/benefit analysis of operating each subplan of the query execution plan asynchronously.

### SUMMARY OF THE INVENTION

The foregoing and other objects, features, and advantages of the present invention will be apparent from the following detailed description of the preferred embodiments which makes reference to several drawing figures.

One group of preferred embodiments of the present invention are methods for performing advanced cost/benefit analysis of subplans of a query execution plan, in a computer system having a database software server. The method augments a cost estimation model, obtained from an optimizer of the software server after determination of an optimal query execution plan, with a cost/benefit analysis of operating each subplan of the query execution plan asynchronously. It calculates a subplan elapsed time benefit of making the subplan asynchronous using a set of cost estimates for each subplan operation and knowledge of the execution sequence of the query execution plan operations, all provided by the query optimizer. A set of subplans for asynchronous execution is chosen to form an optimal set of subplans while respecting a resource constraint, for providing a maximal reduction of the total query elapsed time while conserving system resources of the software server. Some preferred method embodiments are implemented in a federated environment and others in a non-federated environment.

Another group of preferred embodiments of the present invention are systems implementing the above-mentioned method embodiments of the present invention.

Yet another group of preferred embodiments of the present invention includes a computer usable medium tangibly embodying a program of instructions executable by the computer to perform method steps of the above-mentioned method embodiments of the present invention.

### BRIEF DESCRIPTION OF THE DRAWINGS

Referring now to the drawings in which like reference numbers represent corresponding parts throughout:

FIG. 1 illustrates a block diagram of an exemplary computer hardware and software environment, according to the preferred federated embodiments of the present invention;

FIG. 2 illustrates a flowchart of the basic advanced cost/benefit analysis utility algorithm, according to the preferred federated embodiments of the present invention;

FIG. 3 illustrates a flowchart of the extended advanced cost/benefit analysis utility algorithm, according to the preferred federated embodiments of the present invention;

FIG. 4 illustrates a flowchart of the method used to determine whether SHIP/RPD operator is eligible for an ATQ operator, according to the preferred federated embodiments of the present invention;

FIG. 5 illustrates a flowchart of the method used to predict whether use of sibling asynchrony will reduce elapsed time if the SHIP/RPD operator is made asynchronous, according to the preferred federated embodiments of the present invention;

FIG. 6 illustrates a flowchart of the method used to predict whether use of producer-consumer asynchrony heuristic will reduce elapsed time if the SHIP/RPD operator is made asynchronous, according to the preferred federated embodiments of the present invention;

FIG. 7 illustrates a control-flow and data flow of an exemplary query execution plan;

FIG. 8 illustrates a block diagram of an exemplary computer hardware and software environment, according to the preferred non-federated embodiments of the present invention;

FIG. 9 illustrates a flowchart of the basic advanced cost/benefit analysis utility algorithm, according to the preferred non-federated embodiments of the present invention;

FIG. 10 illustrates a flowchart of the extended advanced cost/benefit analysis utility algorithm, according to the preferred non-federated embodiments of the present invention;

FIG. 11 illustrates a flowchart of the method used to determine whether a decision point operator is eligible for an ATQ operator, according to the preferred non-federated embodiments of the present invention; and

FIG. 12 illustrates a flowchart of the method used to predict whether use of sibling asynchrony will reduce elapsed time if the decision point operator is made asynchronous, according to the preferred non-federated embodiments of the present invention.

### DETAILED DESCRIPTION OF THE PREFERRED EMBODIMENTS

In the following description of the preferred embodiments reference is made to the accompanying drawings which form the part thereof, and in which are shown by way of illustration specific embodiments in which the invention may be practiced. It is to be understood that other embodiments may be utilized, and structural and functional changes may be made without departing from the scope of the present invention.

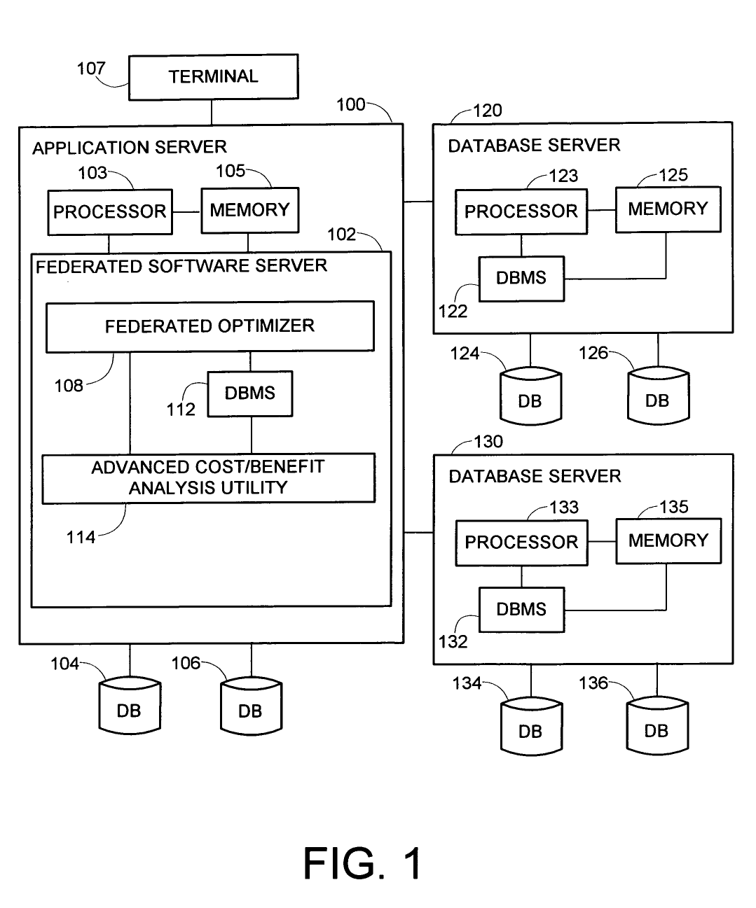

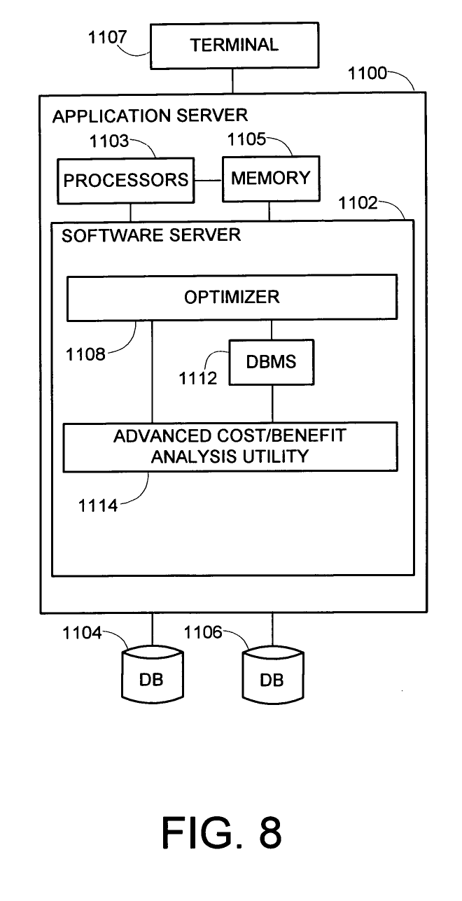

The present invention can be executed in a federated environment, illustrated in FIGS. 1-6 and described in the Federated Preferred Embodiments section. It is also applicable to a non-federated environment, illustrated in FIGS. 8-12 and described in the Non-Federated Preferred Embodiments section.

### A. FEDERATED PREFERRED EMBODIMENTS

The federated preferred embodiments of the present invention are directed to a system, method and program storage device embodying a program of instructions executable by a computer to perform the method of the present invention for advanced cost/benefit analysis of subplans of a query execution plan, in a computer system having a federated database software server. The method augments a cost estimation model, obtained from a conventional federated optimizer of the federated software server in a relational DBMS, after determination of an optimal query execution plan, with an advanced cost/benefit analysis of operating each subplan of the query execution plan asynchronously, for queries executed in a federated environment, accessing data residing in multiple data sources and possibly stored in different formats. It calculates a subplan elapsed time benefit of making the subplan asynchronous using a set of cost estimates for each subplan operation and knowledge of the execution sequence of the query execution plan operations, all provided by the query optimizer.

The solution implemented in the present invention introduces one or more special operators into a query execution plan to achieve the asynchrony. Each such operator defines a portion of the execution plan that can be executed asynchronously and independently of other portions. However, this operator has an associated cost that may outweigh the performance benefit of the asynchrony that it enables. Thus, the present invention is directed to an autonomic algorithm which can help the conventional federated optimizer decide when this overhead is justified, by using additional knowledge, not presently reflected in the conventional resource-consumption based cost model. It augments the federated optimizer's cost model by making it take into account the latency of operations and operator sequence in the execution plan so that the present invention can decide whether a query will benefit from asynchrony. The method is applied in the phase that comes after different plan alternatives are considered and the best query execution plan is chosen. Thus, it does not change the existing federated optimizer cost model calculations and can be implemented in an add-on, portable utility. The invention also uses some heuristics that were arrived at using experimentation to decide whether enabling asynchronous access to remote sources helps query performance.

The present invention requires only limited additional information over the data presently available from the optimizer and results in an execution plan with substantially improved performance. It is preferably implemented in a federated database environment, such as WebSphere II V9.1, and is thus described herein using a federated optimizer and a federated query execution plan. However, it is also applicable to non-federated database systems, such as DB2, and their optimizers and query execution plans.

FIG. 1 illustrates an exemplary computer hardware and software environment usable by the federated preferred embodiments of the present invention to enable the advanced cost/benefit analysis method of the present invention. FIG. 1 includes a federated software server 102, sometimes called a multi-database server or a federated data server, having one or more conventional processors 103 executing instructions stored in an associated computer memory 105 and a console terminal 107. The memory 105 can be loaded with instructions received through an optional storage drive or through an interface with a computer network.

The processor 103 is connected to one or more electronic data storage devices 104, 106, such as disk drives, that store one or more relational databases. They may comprise, for example, optical disk drives, magnetic tapes and/or semiconductor memory. Each storage device permits receipt of a program storage device, such as a magnetic media diskette, magnetic tape, optical disk, semiconductor memory and other machine-readable storage device, and allows for method program steps recorded on the program storage device to be read and transferred into the computer memory. The recorded program instructions may include the code for the method embodiments of the present invention. Alternatively, the program steps can be received into the operating memory from a computer over the network.

Operators of the terminal 107 use a standard operator terminal interface (not shown), to transmit electrical signals to and from the federated server 102, that represent commands for performing various tasks, such as search and retrieval functions, termed queries, against the database stored on the electronic data storage device 104, 106. In the present invention, these queries conform to the Structured Query Language (SQL) standard, and invoke functions performed by a DataBase Management System (DBMS) 112, such as a Relational DataBase Management System (RDBMS) software. Although the preferred embodiments of the present invention are preferably implemented in a federated database environment, such as WebSphere II V9.1, the present invention is also applicable to non-federated database systems, such as DB2, and their optimizers and query execution plans. Thus, it is also applicable to any RDBMS software that uses resource-consumption based cost model for choosing the best query plan alternative, such as the DB2 product, offered by IBM for the AS400, z/OS or OS/2 operating systems, the Microsoft Windows operating systems, or any of the UNIX-based operating systems supported by the DB2. Those skilled in the art will recognize, however, that the present invention has application to any RDBMS software that uses SQL, and may similarly be applied to non-SQL queries, XML and Web applications.

Federated software server 102 of FIG. 1 has access to an advanced cost/benefit analysis utility 114 of the present invention and a federated optimizer 108, in addition to a local data source DBMS 112 and databases on multiple data storage devices 104, 106, each of which may reside on different systems and may store data in different formats. Applications on federated software server 102 may use at least one standard SQL, XML or Web communication line 110 connecting the federated server 102 to at least one remote server, such as database servers 120 and 130, to obtain access to databases of multiple data sources such as DBMS 122 and 132 and data storage devices 124, 126, 134 and 136, each of which may be a DB2 or non-DB2 source, and may reside on different systems and may store data in different formats. Database servers 120, 130 have their own processors 123, 133 and memory 125, 135.

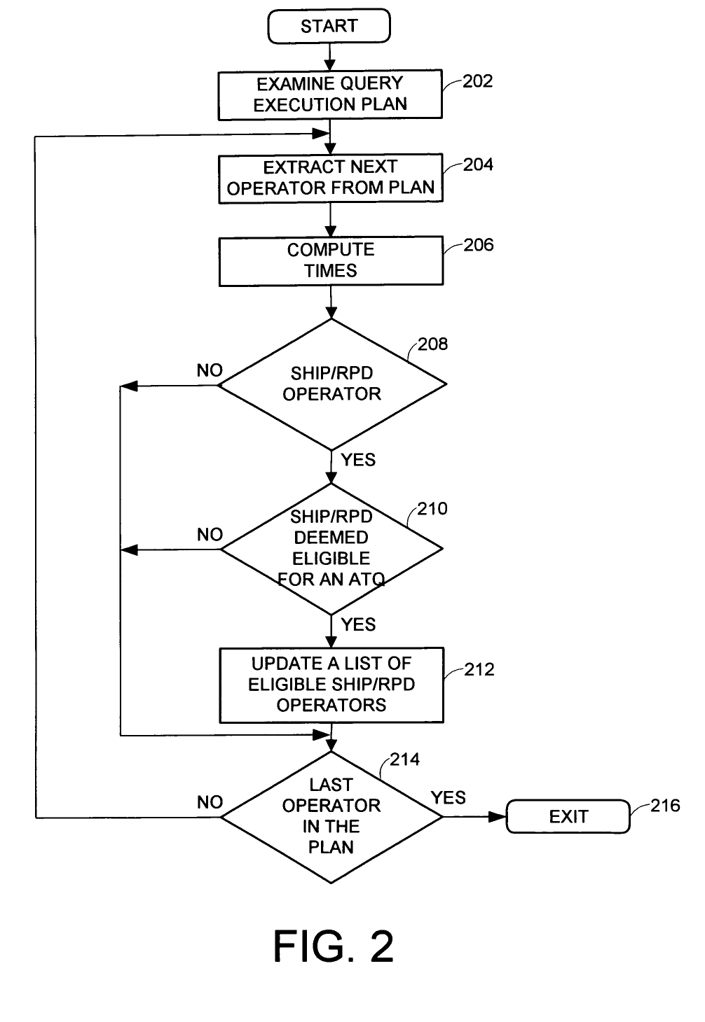

Flowchart of the basic algorithm of the advanced cost/benefit analysis utility 114 is illustrated in FIG. 2 and begins with examination of a query execution plan temporarily stored in memory 105 that describes the strategy chosen by the federated optimizer 102 to implement the query. This plan generally involves both local processing on the federated server 102 itself, as well as remote processing on other servers, such as database servers 120, 130, providing access to databases where data needed by the query reside. The query execution plan consists of a number of operators, each of which is responsible for a particular processing operation, such as aggregation, join, or application of predicates. The operators are logically arranged in a tree structure. The lowest-level operators are processing operators that access data, process data and move them upwards to other, consuming operators. Each federated execution plan includes one or more federated fragments, which may be defined by a data shipping or remote pushdown (SHIP/RPD) operator, that demarcates the point in the plan where processing is delegated to a remote DBMS, such as DBMS 122, 132.

The advanced cost/benefit analysis utility 114 algorithm's purpose is to judiciously introduce additional operators into the execution plan so that different parts of the plan can execute concurrently. In the preferred embodiment of the present invention these operators are called TQ (Table Queue) and each TQ operator defines a portion of the execution plan, called a distributed subsection, that can be executed asynchronously and independently of other distributed subsections. However, because it involves the creation of either an additional process or a new thread during execution, as well as additional overhead to move data between the new process/thread and existing processes or threads, the TQ operator has an associated cost that may exceed the performance benefit of the asynchrony that it enables. Thus, the algorithm has to weigh the likely benefit of the TQ operator, in terms of elapsed time reduction, against the additional cost it incurs.

In the preferred embodiment of the present invention, asynchrony is enabled by a special operator, indicator or flag, such as the TQ operator. TQ is the same mechanism used conventionally in existing Massively Parallel Processing (MPP) systems for a different purpose, to alter the partitioning of data among nodes of the system. In the context of the present invention, the TQ operators are not used to change the partitioning of data in the execution plan but are only used for the purpose of enabling asynchrony. For this reason, they are called Asynchronous Table Queue (ATQ) operators.

The main goal of the present invention is to enable concurrency among multiple remote data sources 124, 126, 134, 136, executing on behalf of a query submitted to the federated server 102, although it is also applicable to enable concurrency between remote and local processing using data sources 104, 106. Thus, the algorithm of the present invention only considers the placement of ATQ operators directly above SHIP/RPD operators in the input plan, because such placement turns a remote portion of the query, defined by the SHIP/RPD operator, into a distributed subsection able to execute independently of other local or remote distributed subsections. However, as explained above, the algorithm only places ATQ operators above SHIP/RPD operators in cases where the ATQ operator's benefit is expected to outweigh its cost.

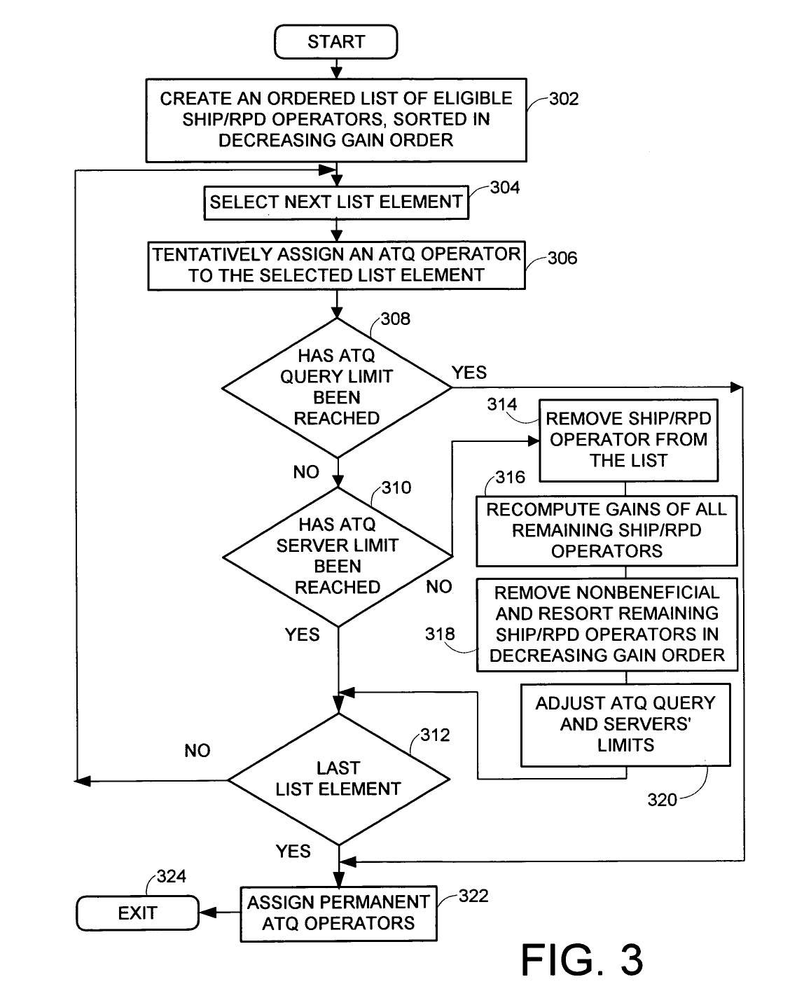

An extended algorithm of the advanced cost/benefit analysis utility 114 is used for optimized distribution of ATQ operators across SHIP/RPD operators when the degree of asynchrony is limited by resource constraints placed on the federated server 102 and possibly at the remote servers 120, 130 as well. Flowchart of this extended advanced cost/benefit analysis utility, according to the preferred embodiments of the present invention, is illustrated in FIG. 3 and described in later sections. A set of subplans for asynchronous execution is chosen to form an optimal set of subplans while respecting a resource constraint, for providing a maximal reduction of the total query elapsed time while conserving system resources of the software server.

The method of the advanced cost/benefit analysis utility 114, shown in FIG. 2, examines the optimized query execution plan, in step 202, in order to obtain the following information. It inputs the time estimates provided by the federated optimizer for each operator in local and remote parts of the query, which include the first row time, defined as the time to retrieve the first row of the result set, and the total time, defined as the time to retrieve all rows of the result set. It also inputs the estimated row cardinality received from the federated optimizer that estimates the size of the result set, i.e., number of rows produced by each execution plan operator. Further, it inputs the knowledge about the execution sequence of the operators that comprise an execution plan, the nature of each runtime operator in the execution plan and the sequence in which it invokes its child operators.

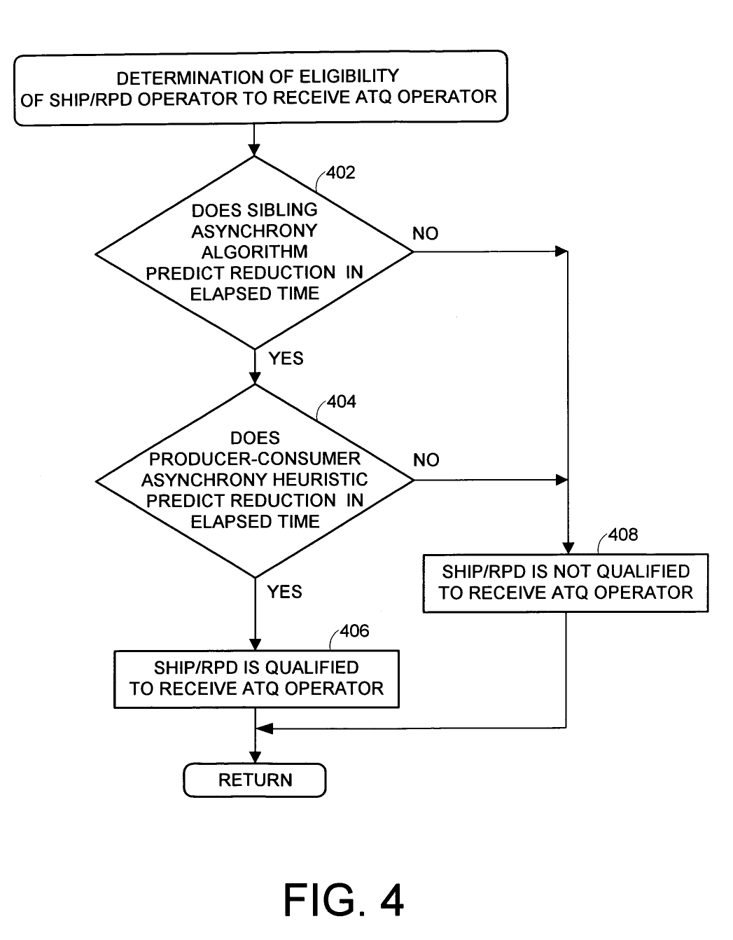

In step 204 the method extracts the next operator of the plan. Step 206 calculates the times, such as first_row_time, total_time, elapsed_total_time and elapsed_first_row_time as described below. Step 208 determines whether the operator is a SHIP/RPD operator and, if so, it examines, in step 210, whether the SHIP/RPD operator is eligible for asynchronous operation via, which is determined according to the algorithms illustrated in FIGS. 4, 5 and 6, in order to place an ATQ operator above the SHIP/RPD operator. Each eligible SHIP/RPD operator is placed in a list, in step 212. For all operators execution continues in step 214 where it is determined whether this is the last operator in the plan. If so, the execution stops, in step 216. Otherwise, the utility continues with step 204 to extract another operator of the plan.

FIGS. 4, 5 and 6 illustrate the parts of algorithm that examine each SHIP and RPD operator in a query execution plan in order to determine whether the benefit gained by making this operator start asynchronously at the beginning of the query and perform in parallel with the rest of the query justifies the performance penalty due to the required use of an additional, ATQ operator.

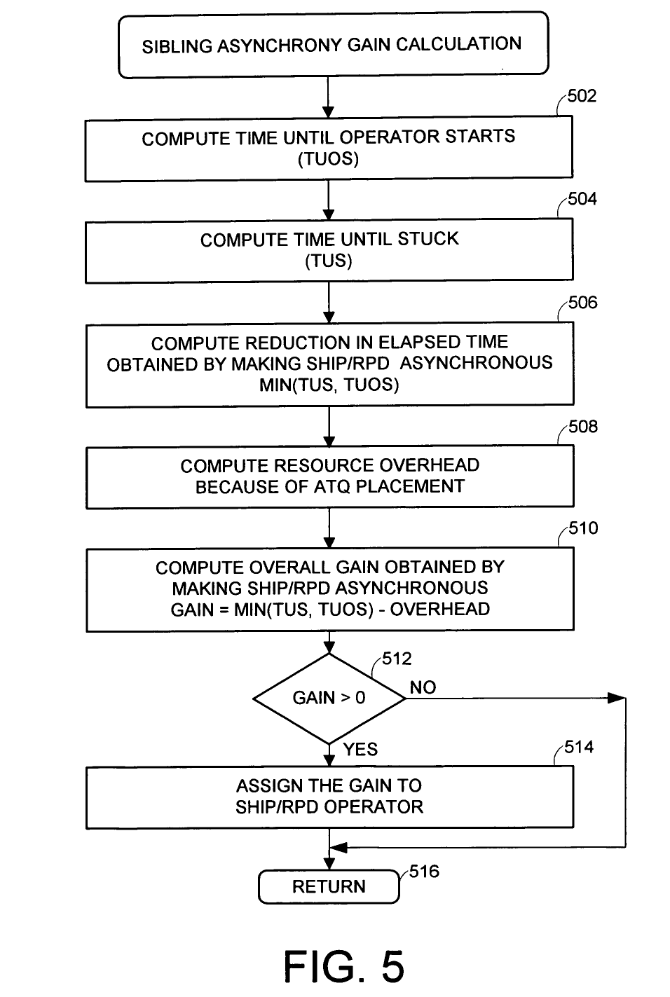

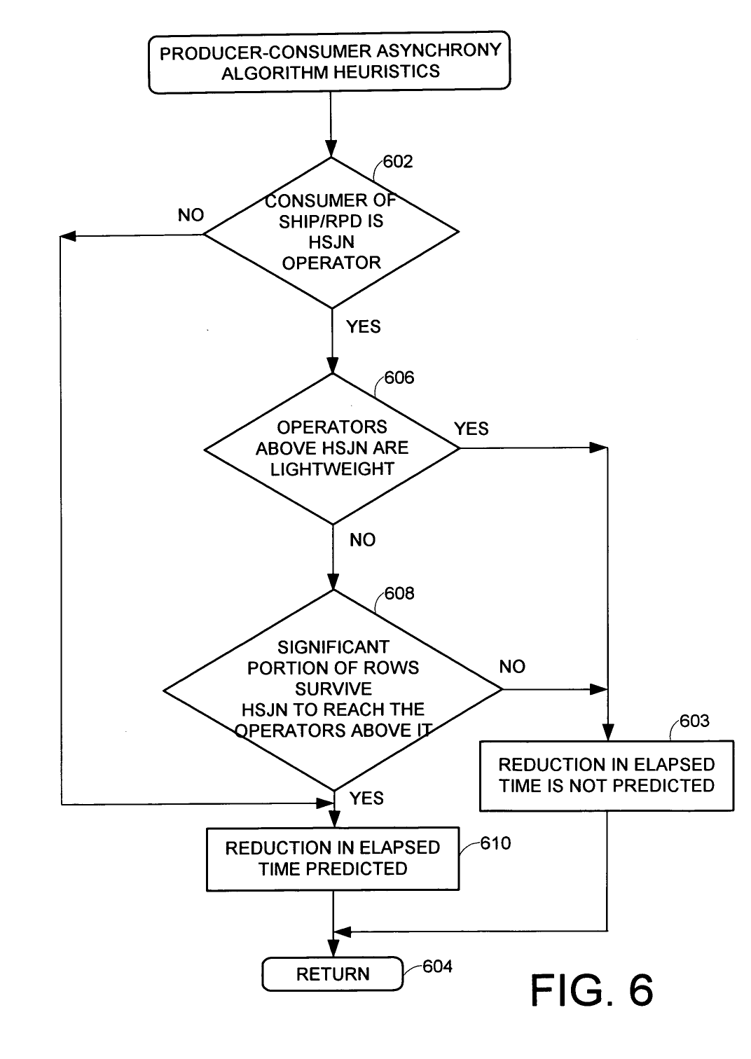

FIG. 4 illustrates a flowchart of the method used to determine whether SHIP/RPD operator is eligible for an ATQ operator, according to the preferred embodiments of the present invention, shown as element 210 of FIG. 2. Each ATQ operator may provide one or both following benefits and the preferred method aspect of the present invention tests for both kinds of benefit, using an algorithm for the first benefit, illustrated in FIG. 5 and a heuristic for the second benefit, illustrated in FIG. 6. The first benefit occurs due to sibling asynchrony which enables concurrent execution of remote query fragments and other operators, local or remote. This is tested in step 402 of FIG. 4 which is supported by the algorithm shown in FIG. 5. FIG. 5 illustrates a flowchart of the method used to predict whether use of sibling asynchrony will reduce elapsed time if the SHIP/RPD operator is made asynchronous, according to the preferred embodiments of the present invention. The second benefit occurs due to producer-consumer asynchrony, which enables, on the federated server, overlapped execution between a remote query fragment producer operator and a consuming operator. This is tested in step 404 of FIG. 4, which is supported by the algorithm shown in FIG. 6. FIG. 6 illustrates a flowchart of the method used to predict whether use of producer-consumer asynchrony heuristic will reduce elapsed time if the SHIP/RPD operator is made asynchronous, according to the preferred embodiments of the present invention. If a reduction in time is predicted by both kinds of asynchrony analysis, for sibling asynchrony and producer-consumer asynchrony, step 406 deems that making the remote query fragment asynchronous is beneficial, and returns opinion that the SHIP/RPD operator and this remote query fragment is eligible to receive an ATQ operator. Otherwise, step 408 returns opinion that the SHIP/RPD operator is not eligible to receive an ATQ operator. Algorithm returns to the main routine of FIG. 2 via step 410.

The gain obtained by adding an ATQ operator above an existing SHIP/RPD operator is obtained because of sibling asynchrony and/or producer-consumer asynchrony. The benefit of the sibling asynchrony of the present invention, tested in step 402 of FIG. 4, is calculated for each query fragment in method steps of FIG. 5. This algorithm estimates, for each remote fragment, the elapsed time benefit of enabling sibling asynchrony between a remote query fragment and other parts of the query, which requires the determination of the two time quantities, TUS and TUOS. Thus step 502 calculates Time Until Operator Starts (TUOS), defined as the time at which this remote query fragment would start executing if it were not initiated asynchronously. Specific rules for each operator, as well as knowledge of the execution sequence of the operators that comprise a plan enable the algorithm to calculate TUOS for each operator and for each SHIP/RPD operator. Step 504 calculates Time Until Stuck (TUS) which defines how long this remote query fragment could run asynchronously until it would require its consumer to start consuming rows due to a lack of buffer space. TUS is the time the remote query fragment takes to fill up with data the buffers provided by the ATQ operator. Once they are full, processing cannot continue until a consuming operator begins to empty the buffers. Calculation of TUS crucially depends on the estimated time to return the first row of the remote fragment's result set.

The ATQ operators are used to enable asynchronous execution of SHIP/RPD operators. By selectively placing ATQ operators above SHIP/RPD operators, remote sources can execute query fragments asynchronously and concurrently with processing on other remote sources or with local processing on the federated server. Enabling overlap of operations in this way can reduce query execution time without causing resource contention, since the concurrent processing takes place on different systems. At the same time, it is not appropriate to indiscriminately make every SHIP/RPD operator in an execution plan asynchronous, since the ATQ mechanism adds an overhead of its own that may more than offset the benefit of asynchrony.

Step 506 calculates min(TUOS, TUS), which is the time saved by the asynchronous method of the present invention. It is the amount by which the query's overall elapsed time would be decreased due to asynchronous execution of this remote query fragment. Step 508 calculates the asynchrony overhead (cost), which includes resource cost of ATQ operators, using the federated optimizer's cost formula. When an ATQ operator is added to an existing sequential execution plan, it introduces cost for additional messages and at least one buffer-to-buffer copy. The ATQ operator reads data from its child operator (SHIP or RPD) and packs it into a buffer. Before a consumer of the ATQ operator reads the data from the ATQ buffer, the data first needs to be unpacked. The extra processing incurred by the ATQ operator adds elapsed time to the total query processing time.

Performance measurements obtained while using the preferred embodiments of the present invention indicated that sometimes the reduction in query processing elapsed time obtained by adding an ATQ operator is not large enough to offset the overhead added by use of the ATQ operator. Hence, the present invention is used to determine how to add ATQ operators above existing SHIP/RPD operators in the plan so that their benefit exceeds the added overhead. Thus, step 510 computes the overall gain or regress obtained by making SHIP/RPD operator asynchronous, by comparison of calculated benefits, obtained in step 506, and costs, obtained in step 508. If it is determined in step 512 that benefits exceed costs, step 514 assigns the gain to the SHIP/RPD operator deeming the sibling asynchrony beneficial. The routine returns in step 516.

Sibling asynchrony occurs when the children of a binary or an n-ary operator, such as a join or a union, execute simultaneously. In the following execution plan example a Merge Join Operator (MGJN) has two children. The fact that the child operators are SHIP operators indicates that the processing for each one is delegated to a remote data source.

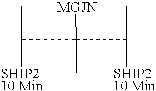

A merge join requires that the input data streams, from SHIP1 and SHIP2, are sorted on the join key. The Merge Join operator itself matches the data from the outer, left child, stream with that of the inner, right child, stream to produce the join result. In a sequential execution, processing of the inner stream (SHIP2) will not be initiated until the outer stream (SHIP1) has begun to produce rows. However, it may be advantageous to initiate processing of SHIP2before SHIP1has begun to produce rows. In the preferred embodiment of the present invention this is achieved by inserting an ATQ operator above SHIP2.

Then, SHIP1 and SHIP2 will start executing approximately at the same time because of the existence of an ATQ operator on top of SHIP2. If each SHIP1 and SHIP2take 10 mins to produce the first row, the plan will have the first row ready on both the outer and inner legs of the join at the end of 10 mins. In the absence of the ATQ operator, the two SHIP operators would have executed serially, SHIP1followed by SHIP2, and the total time to produce the first row would have been 10+10=20 mins. Thus, use of the sibling asynchrony by the present invention allows a performance improvement of 10 mins due to the presence of the ATQ operator. The concept of sibling asynchrony is more general than shown in this example. It applies to concurrent execution of any two or more operators of the plan that are children of either the same binary or n-ary operator, or that are children of different operators in different parts of the plan.

FIG. 6, described below, illustrates execution of an experiment-based heuristic to estimate whether making a remote query fragment asynchronous is likely to provide some benefit in terms of producer-consumer asynchrony and, if so, to deem that it is beneficial to place an ATQ operator above each such remote fragment having a SHIP/RPD operator.

Producer-Consumer Asynchrony results when a plan operator that produces data and another plan operator that consumes the data are able to work simultaneously. In the exemplary plan shown above, the MGJN is the immediate consumer of the ATQ operator. In turn, the ATQ operator is the immediate consumer of the SHIP2 operator. Because SHIP2is located beneath an ATQ operator, it is initiated asynchronously and can proceed independently of other parts of the execution plan. It can, thus, produce rows independently of their consumption by the MGJN operator. The ATQ operator provides needed buffering of data between the SHIP2and MGJN operators. While the ATQ operator is busy reading rows from its producer (SHIP2), the consuming MGJN operator can read the data already written into the TQ buffer by the ATQ operator. Thus, SHIP2and MGJN can proceed at the same time.

The greatest benefit from producer-consumer asynchrony is seen when the producer and the consumer speeds are well matched, providing the maximum time overlap. Ideally, the producer can generate data fast enough to keep the consumer busy most of the time, and conversely, the consumer is fast enough so that the producer seldom needs to wait for it. If the producer is too slow or too fast, when compared to the consumer, one of them becomes a bottleneck and an effective pipeline for data is not established. In such cases, the overhead contributed by the ATQ operator usually outweighs the minimal benefit of producer-consumer overlap and performance of the query may regress due to introduction of the ATQ operator. Thus, it is important to take the effect of producer-consumer asynchrony into account when determining whether a SHIP/RPD operator would benefit from placing an ATQ operator on top of it. Description of heuristic is provided below, in reference to FIG. 6. In many cases the benefit of producer-consumer asynchrony alone can make up the performance penalty of the ATQ operator used to achieve it. If the producer-consumer asynchrony is not beneficial it is disabled. If it is beneficial, the basic method of the present invention terminates and an ATQ operator is placed over every eligible SHIP/RPD operator.

The goal of the present invention is to enable asynchrony while avoiding performance regressions due to the overhead of ATQ operators. The placement of ATQ operators is done taking into account sibling asynchrony as well as producer-consumer asynchrony. ATQ operators are placed to enable sibling asynchrony and the producer-consumer rules are used to ensure that this placement will not lead to performance degradation due to the ATQ operator overhead.

Following algorithms are applied to each SHIP/RPD operator to decide whether an ATQ operator should be placed above that operator. The first algorithm, illustrated in FIG. 5, attempts to quantify the elapsed time improvement that could be achieved due to sibling asynchrony by placing the ATQ operator. The second algorithm, illustrated in FIG. 6, is an experiment-based heuristic that identifies situations in which the potential producer and consumer of the ATQ operator are matched well enough in the speed, at which the producer produces the data and the speed at which the consumer consumes the data, so that the ATQ operator's cost does not dominate the potential elapsed time benefit of producer-consumer overlap. Only if both algorithms indicate a positive effect on elapsed time is a placement of an ATQ operator above the SHIP/RPD operator considered.

The reduction in query elapsed time achieved due to sibling asynchrony is the amount of time a SHIP/RPD operation executes concurrently with other operations in the plan. As shown above in regards to steps of FIG. 5, there are two factors that determine how long the SHIP/RPD operation executes asynchronously: Time Until Stuck (TUS) defined as the time a remote query fragment could run asynchronously until it would require its consumer to start consuming rows, and Time Until Operator Starts (TUOS) defined as the time at which this remote query fragment would start executing if it were not initiated asynchronously.

TUS is used because the remote query fragment can run asynchronously as long as the ATQ operator can buffer the data that the remote query fragment produces. When the buffer fills up, the remote query fragment stops executing until the consumer of data empties out the buffer.

TUOS is calculated in order to determine the likely benefit of making a remote query fragment execute asynchronously, to be activated as soon as the query starts, as opposed to the fragment activated in a sequence dictated by a serial thread of control. If the remote query fragment was not started asynchronously, TUOS equals the point in time since the beginning of the query at which the remote fragment would be activated. This is exactly the amount of time during which the remote query fragment could execute concurrently with the rest of the processing in the query.

The benefit of asynchrony for the remote query fragment ends when the first of these two events occurs, i.e., either when the ATQ buffers get filled and the remote query fragment needs to wait or when the time comes at which the remote query fragment would have started executing synchronously. Thus, the overlap or gain because of asynchrony is defined as min (TUS, TUOS) and it is the reduction in the query's elapsed time.

This benefit comes at the cost of consumption of resources by the ATQ operator to provide asynchrony. If this resource consumption is captured by the term overhead, and the overhead is converted to an elapsed time, the real benefit because of asynchrony is:
Min(TUS, TUOS)−overhead.

The following timing diagrams show different query execution patterns where TUS and TUOS appear in different timing orders. In the following diagrams, the SHIP/RPD operator produces the data and puts it in ATQ buffers. The data from the ATQ buffers may be consumed by an operation that comes before ATQ in the control sequence. This operator could be any operator depending on the execution plan.

In the following example SHIP/RPD operator finishes producing rows before its consumer starts. Thus, the remote query fragment, the producer of data, is not waiting for the consumer to read the data and TUS>TUOS. Time t0 denotes start of the query, when producer starts working in its own subsection. Time t1 denotes when the producer starts producing rows, t2 denotes when the producer finishes producing all the rows, t3 denotes when consumer starts reading rows and t4 denotes when the operation completes.

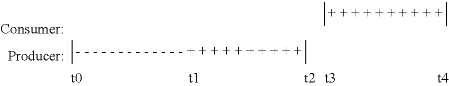

In this diagram the producer has produced all the rows of its result set without filling the ATQ buffer completely. Hence TUS is virtually infinity but since the result set has been completely produced by time t2, the producer stops working after time t2. Hence time t2 can be used in this example to replace TUS. TUOS in this query is time t3, from the beginning of the query, since that is when the consumer starts reading the data. The benefit because of asynchrony in this case is:
Min(TUS, TUOS)−overhead=t2−overhead

In following examples the remote query fragment potentially gets stuck waiting for the consumer to read the rows. In this case, TUS<TUOS.

a) Producer is really stuck and SHIP/RPD operation is stuck since the buffer is full. Time t0 denotes start of the query when the producer starts working in its own subsection, t1 denotes that producer starts producing rows, t2 denotes that the producer gets stuck as ATQ buffers fill up, t3 denotes that consumer starts reading rows, t4 denotes that the producer finishes producing rows and t5 denotes that the operation completes.

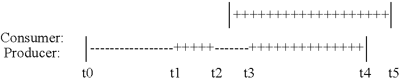

In this example the SHIP/RPD operator gets stuck at t2, since it filled its buffer and it needs to wait for the consumer to start. So, TUS is t2 and TUOS is t3. The benefit because of asynchrony is:
Min(t2, t3)−overhead=t2−overhead

b) Producer work overlaps with consumer but neither producer nor remote query fragment are stuck, so TUOS<TUS. Time t0 denotes start of the query, when producer starts working in its own subsection, t1 denotes that the producer starts producing rows, t2 denotes that the producer would have gotten stuck as ATQ buffers would fill up, t3 denotes that consumer starts reading and t4 denotes that the operation completes.

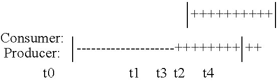

In this example the consumer starts before the producer gets stuck. The producer at no point in time fills the ATQ buffer completely and hence never gets stuck. So, TUS is infinity and TUOS is t3. The benefit because of asynchrony is
Min(infinity, t3)−overhead=t3−overhead.

The overhead of the ATQ operator is computed as the resource consumption cost of ATQ and is provided by the federated optimizer. The following examples show how TUS and TUOS are computed for various operators in a given execution plan.

Computation of Time Until Stuck

The Time Until Stuck (TUS) of a SHIP/PRD operator is the length of time that the SHIP/PRD operator can execute before it must wait for the consuming operator to become active. This time is typically limited by the buffering capacity of the intervening ATQ operator. Once the ATQ buffers are filled, the SHIP/RPD operator needs to wait until the consumer of the ATQ operation becomes active and starts reading the data. Reading removes data from the ATQ buffers and creates space for new data to be inserted by the SHIP/PRD operator. Thus, the Time Until Stuck for a SHIP/RPD operator is the length of time it can execute until it fills the ATQ buffer.

An ATQ operator can be used in one of the two modes: non-spilling mode, where an ATQ operator has a predefined limited amount of buffer space available, and spilling mode, where an ATQ operator has a virtually unlimited amount of buffer space available, limited only by the available space on the storage device. Spilling mode is only used to avoid a possible deadlock. The decision whether the ATQ operator should be used in the spilling or non-spilling mode is made after the query is optimized and is not known during the optimization process. The federated optimizer conservatively assumes that the ATQ will operate in non-spilling mode and assumes a predefined limited buffer space for its cost calculations.

Formula for calculating TUS uses following terms defined below:
buffer_sz: the ATQ buffer size in bytes. The optimizer is aware of this limit.
num_rows: the optimizer's estimate of the number of rows that a particular SHIP/RPD produces.
row_width: the average row width, in bytes, of each row produced by a SHIP/RPD. The optimizer can compute this number by adding up the sizes of all the columns that constitute a row.
total_time: the optimizer's estimate of how much time in seconds it will take to retrieve all the rows from the SHIP/RPD.
first_row_time: the optimizer's estimate of how much time in seconds it will take to retrieve the first row of the result set from SHIP/RPD.

The federated optimizer estimates that it takes ‘total_time’ amount of time to retrieve (num_rows*row_width) bytes. However, if the ATQ buffer cannot accommodate all the rows, it will be full before all the rows are retrieved. Time needed to fill the ATQ buffer is defined as: (Time to retrieve 1 byte from SHIP/PRD)*buffer_sz, where (Time to retrieve 1 byte)=total_time/(total size of rows in result set)=total_time/(num_rows*row_width).

Thus, the time to fill the ATQ buffer is this quantity multiplied by buffer_sz:
[total_time/(num_rows*row_width)]*buffer_{—}sz

Depending on the type of the query fragment, the data may or may not flow evenly over time. For a pipelined remote plan fragment, it can be assumed that rows begin to flow back almost immediately and are returned evenly over time. However, if the remote plan fragment is dammed, the first row is returned after a long wait and subsequent rows are returned evenly over time. If the execution time of a query is represented as a series of dashes (−) and the generation of rows is represented as plus signs (+), the two types of remote query fragment plans are:

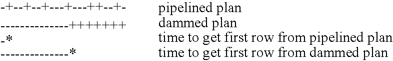

In both kinds of plan, the time to get the first row (first_row_time) is related to the time between the beginning of the fragment's execution and the time the first row is returned. In a fragment with a pipelined plan, this time is relatively small compared to the fragment's overall execution time. In a fragment with a dammed plan, the time to return the first row represents a larger proportion of fragment's overall execution time. To take this unevenness of return of data into account, the federated optimizer keeps an estimate of the time a query has to wait till it sees the first row of result data set, the first_row_time.

The formula above is modified to reflect the fact that data may be returned unevenly. This complication affects the part of the formula that calculates the rate at which data is retrieved. The first row of data is retrieved in first_row_time and fills row_width bytes in the ATQ buffer. The rest of the data i.e., (num_rows−1)*row_width bytes, is retrieved in (total_time−first_row_time). Hence the rate per byte of retrieving rows from the 2^{nd} row onwards is
(total_time−first_row_time)/((num_rows−1)*row_width)seconds per byte

At this rate, the remaining space in the ATQ buffer (tq_buffer_size−row_width) is filled in
(tq_buffer_size−row_width)*(total_time—first_row_time)/((num_rows−1)*row_width)seconds

TUS is the sum of the first_row_time and the time to finish filling the ATQ buffer:
TUS=first_row_time+(tq_buffer_size−row_width)*(total_time−first_row_time)/((num_rows−1)*row_width)
Computation of Time Until Operator Starts

The time until operator starts (TUOS) is defined as the time at which an operator would start executing if it was not initiated asynchronously in a given federated query execution plan. Query execution plan consists of a number of operators, each of which is responsible for a particular processing operation, such as aggregation, join, or application of predicates. The operators are logically arranged in a tree structure. The plan control flow and data flow have to be taken into account to determine how the plan is executed at runtime. The control flow in the plan is determined by the sequence in which the operators are activated by their respective consumers. When the query begins to execute, the first operator in the plan, the top-most operator, gains control. The first operator starts or activates the next operator so that the operator will start the necessary work to produce its result set. When the operator under consideration is not a leaf operator in the plan tree, this work may take the form of starting other operators. When the operator under consideration is a leaf-level, bottom-most operator in the plan tree, the nature of the work is to produce data, so it may involve reading a table or an index or shipping a query fragment to a remote server. Control is passed downwards through the plan so as to start various operators and eventually to start the data flow. The sequence in which the control is passed from one operator to other is described using rules defined for each operator.

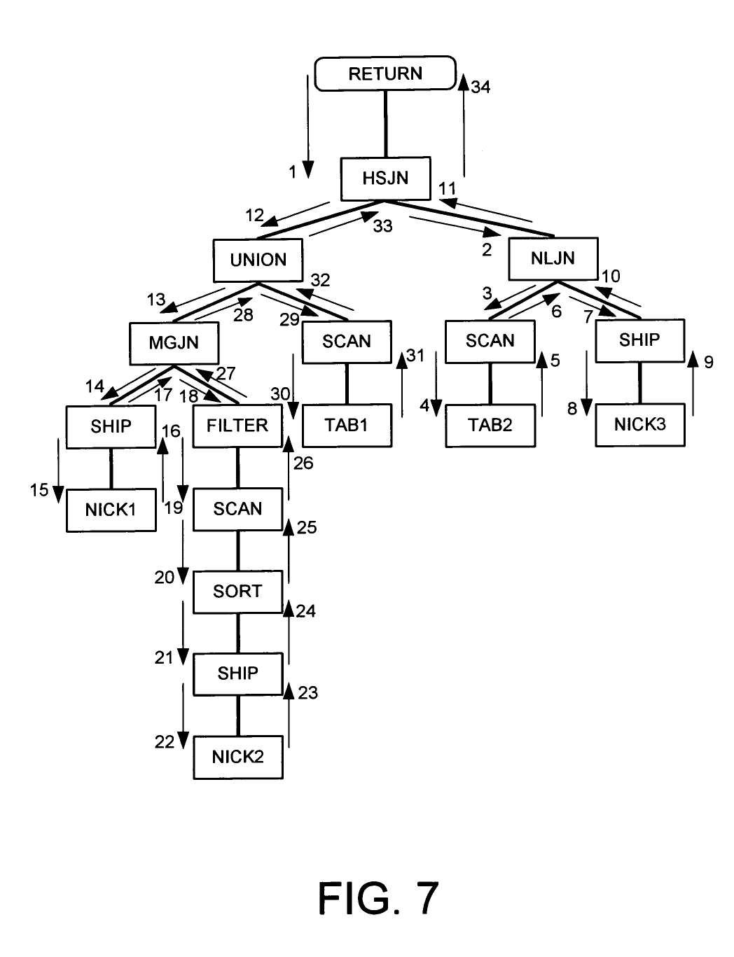

When control reaches the leaf-level operators in the plan, the operators respond by accessing data, processing them, and moving them upwards to other consuming operators. Sending the data upwards in the plan constitutes the data flow. FIG. 7 demonstrates control-flow and data flow of an exemplary query execution plan. The control flow of the plan is annotated by arrows and the increasing order of numbers. The upward arrows also denote the data flow. The example shows that control flows downward and then upward in the plan, while data generally flow upwards and that there is an overlap in the path that control and data flow take.

For each operator, TUOS is the elapsed time relative to the beginning of query execution at which control first reaches that operator. A federated execution plan includes one or more SHIP/RPD operators that indicate the point in the plan where a query fragment is sent to a remote DBMS. TUOS needs to be computed for each operator in a federated query optimizer plan, as it is needed by the sibling asynchrony algorithm to determine whether it would be beneficial to make a SHIP/RPD operator asynchronous.

Computing TUOS for an operator involves adding up the time taken by each operation preceding the given operator, in control flow sequence executed sequentially, while taking into account the overlap of operations that may be executed concurrently with the operators that precede the operator in the control flow sequence. The algorithm that calculates TUOS for an operator needs to know the precise sequence in which the operators in the execution plan are processed, with respect to the control flow and the data flow. This information is needed to compute an estimate of the elapsed time between the start of execution of the query and the point in time at which the operator will be activated by its consumer and it is made available to the algorithm in the form of rules.

The rules for operators that are relevant to the present invention are summarized below. For a UNION operator, read all rows from the left (first) child, then read all rows from the second child, etc., until all children are processed. Result rows are produced once the first child returns the first row. For a Nested Loop Join operator, read one row from the left (outer), find matching rows in the inner leg and return them as result, read next row from the outer, etc. For a Merge Join operator, read the first row from the left (outer), then read the first row from the right (inner), then merge matching rows to produce result rows. For a Hash Join operator, read all the rows from the inner leg, then read all rows from the outer leg, producing result rows from matches. Each operator can be seen as a transformer of data because it accepts one or more data streams as input, applies certain transformations to the data stream and produces one or more data streams as output. These data streams are then fed to the next operator in sequence as determined by the optimizer's execution plan.

Each operator takes a certain amount of time to process the data stream. This time depends on the nature of the operator, number and width of rows processed by the operator and system resources, such as memory, available to the operator to get the work done. The time taken by the operator to produce all the rows in the output stream is termed as the total_time of the operator. The time taken by the operator to produce the first row in the output stream is termed the first_row_time of the operator. Both times are measured with respect to the time that the operator begins to execute. The first_row_time of an operator is important because some operators treat the first row of the result set differently from the subsequent rows. The federated optimizer makes the estimate of first_row_time and total_time for each operator available to the algorithm that computes TUOS.

As the algorithm that computes TUOS works its way through the execution plan, it calculates and keeps track of the following two quantities for each operator in the execution plan. Elapsed_total_time is the time until the given operator produces all rows of its output data stream. This time is measured from the beginning of the query. It is an accumulation of the time spent executing the given operator and those that precede it in control flow sequence until the point at which its output is complete. Elapsed_first_row_time is the time until the given operator produces the first row in its output data stream. This time is measured from the beginning of the query. It is an accumulation of the time spent executing the given operator and those that precede it in control flow sequence, up to the point at which it is able to produce its first output row. In order to produce the first row of a given operator's output data stream, one or more of the preceding operators may have been required to produce all rows of their output data because of the nature of the operator.

TUOS is computed in respect to the position of each branch in the query plan execution tree. Any child of a binary or n-ary operator constitutes a branch in the plan. The RETURN operator, the first operator in the plan, also starts a branch. From the control sequence of operators, one can deduct the order in which branches are activated. In the exemplary query execution plan of FIG. 7, the left branch of NLJN (marked by numbers 3 through 6) is activated before the right branch of NLJN (marked by numbers 7 through 10).

The TUOS of any operator in a branch can be alternatively defined as the TUOS of the topmost operator of the previous branch in control sequence+elapsed_total_time or elapsed_first_row_time of the topmost operator of the previous branch, depending on the rules for the operator of which these are branches. This definition of TUOS is recursive and gives a practical way of computing TUOS. The definition of TUOS can be intuitively understood as follows. Conceptually, the execution plan is a sequence of branches. Any given branch in a plan starts after a certain time has elapsed since the previous branch started. The following diagram explains this definition. The diagram assumes that the rules of the operators involved dictate that the next branch starts only when the previous branch has returned all the rows.

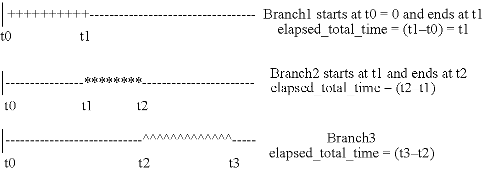

In the following formulas, the expression “TUOS of a branch” means TUOS of the topmost operator in that branch. Similarly, “elapsed_total_time” of a branch is synonymous with elapsed total time of the topmost operator in that branch. TUOS of branch1 assumes that t0=0.

$$\begin{matrix}TUOS for branch 2 = TUOS ( branch 1 ) + \\ elapsed\_total \_time of branch 1 \\ = t 0 + ( t 1 - t 0 ) \\ = t 1\end{matrix}$$

Thus, branch2 starts after the elapsed_total_time of branch1, i.e. at time t1.

$$\begin{matrix}TUOS of branch 3 = TUOS ( branch 2 ) + \\ elapsed\_total \_time of branch 2 \\ = t 1 + ( t 2 - t 1 ) \\ = t 2\end{matrix}$$

Thus, TUOS of branch3 is the sum of the elapsed_total_times of previous branches.

In reality, the rules of operators dictate that sometimes the elapsed_first_row_time of the previous branch would need to be used in the computation of TUOS of a branch instead of the elapsed_total_time. One such case is the merge join operator. The TUOS of its inner branch equals the elapsed_first_row_time of its outer branch.

The general principle of the algorithm of the present invention that can be utilized to compute TUOS is presented below. The algorithm starts out with the very first branch, which starts with the first operator in the plan, the RETURN operator. Since the first operator starts as soon as the query starts executing, its TUOS is 0. When the algorithm recursively traverses the branches in the plan, it computes the elapsed_total_time and elapsed_first_row_time using the rules of the operators for the branch. This branch's TUOS+elapsed_total_time or elapsed_first_row_time is provided as the TUOS to the next branch. The algorithm continues until all the branches have been traversed. When a SHIP/RPD operator is reached as a part of traversing branches, the algorithm computes the TUS, TUOS and the ATQ overhead to compute the gain due to asynchrony in order to make the decision of whether the SHIP/RPD should be marked as eligible for an ATQ operator.

The elapsed_total_time and elapsed_first_row_time are computed differently for different operators. For a leaf-level operator in the plan, the elapsed_total_time and elapsed_first_row_time are computed as the total_time and first_row_time of the operator, respectively. For a unary non-leaf operator, except a TQ operator, elapsed_total_time is computed as the (elapsed_total_time of the child operator+the total_time of the current operator). Similarly, elapsed₁₃ first_row_time for the operator is (elapsed_first_time of the child operator+the first_row_time of the current operator).

For a MGJN operator, the elapsed_total_time is computed as (elapsed_total_time of the left child+elapsed_total time of the right child+total_time of the MGJN operator). The elapsed_first_row_time is computed as (elapsed_first_row_time of the left child+elapsed_first_row_time of the right child+first_row_time of the MGJN operator). For a UNION operator, the elapsed_total_time is computed as the sum of elapsed_total_times of all the legs of the UNION+total_time of the Union operator. The elapsed_first_row_time is computed as the elapsed_first_row_time of the leftmost leg+first_row_time of the UNION operator. The computation for other join operators (HSJN and NLJN) is similar and follow the rules for those operators.

The computation of elapsed_total_time and elapsed_first_row_time for a TQ operator is slightly more involved. The presence of a TQ operator in a plan signifies that not all operators will be executed sequentially. Each TQ defines a distributed subsection that can begin execution independently of other distributed subsections and, because of the overlap, a reduction in overall query elapsed time is achieved.

To calculate how much reduction in elapsed time would be obtained because of a particular ATQ operator, TUS and TUOS have to be considered. TUS for the ATQ operator's producer shows how much time the producer of data for the ATQ operator would take to fill the TQ buffer. TUOS is calculated for the top-most operator in the distributed subsection and is considered to be the same for the ATQ operator, and denotes, if the ATQ operator had not been there, how much time would have to elapse since the beginning of the query for the distributed subsection defined by the ATQ operator to be activated.

The elapsed time reduction because of an ATQ operator is the smaller of these two quantities. The elapsed time of the query is reduced by the amount of time the producing operators for the ATQ operator can execute concurrently with other parts of the query. They can execute either until the ATQ operator above them is stuck, or until the ATQ operator's consumer starts the top-most operator in ATQ operator's subsection, whichever happens first. Thus, the elapsed time reduction due to this ATQ operator is min(TUS, TUOS) for the ATQ operator.

If the elapsed time of the first operator in the distributed subsection defined by the ATQ operator was elapsed_total_time before taking into consideration the reduction because of ATQ, the final elapsed_total_time for the ATQ operator is (elapsed_total_time−min(TUS, TUOS)). In order to compute the elapsed_first_row_time because of an ATQ operator, it must be noted that, when the producer produced the first row, enough buffer space was available and it did not have to wait for the consumer to read the data, hence TUS is infinity. The formula for elapsed_total_time for ATQ can be modified as (elapsed_first_time−TUOS) to give the elapsed_first_row_time for the ATQ operator.

The following example illustrates computation of TUOS for the SHIP operator marked SHIP1in the following plan fragment.

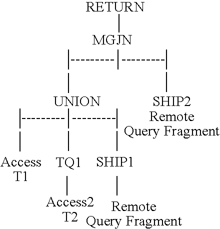

Convention ETT(op_name) is used in this example to denote the elapsed_total_time for operator op_name and EFT(op_name) is used to denote the elapsed_first_row_time for operator op_name. Thus, the elapsed_first_row_time for MGJN is ETT(MGJN).

The algorithm starts with the TUOS of 0. Hence, the first branch Access1-T1 will starts with a TUOS of 0. The next branch in sequence is TQ1-Access2-T2. Because TUOS for any operator in a branch is the sum of TUOS of the topmost operator of the previous branch and the ETT or EFT of the current branch, depending on the operator of which these are branches, and, thus, in this case, the TUOS for TQ1 is
TUOS(Access T1)+ETT(Access1)=0+ETT(Access1)=ETT(Access 1)

ETT, as opposed to EFT, of Access T1 is used here since the UNION rules dictate that a UNION leg must be executed completely before the next leg can be started. Next, algorithm needs to evaluate ETT and EFT for the TQ1 branch, so that the TUOS for next branch Access3 can be evaluated. Using the rules for TQ, the ETT for TQ1 is:
ETT(Access2)−min(TUS, TUOS)=ETT(Access2)−min(TUS, ETT(Access1))

The TUOS for the next branch, SHIP1, is thus:
TUOS for TQ1+ETT(TQ1)=ETT(Access1)+ETT(Access2)−min(TUS, ETT(Access1))

The left leg of MGJN is the branch preceding the SHIP2 branch. TUOS of SHIP2 is TUOS of left leg of MGJN+EFT of the left leg of the MGJN. MGJN rules dictate that the right branch of MGJN is started as soon as first row is available on the left leg of MGJN, so EFT of left leg of MGJN is:
TUOS of UNION+EFT (UNION)=0+EFT(Access T1)+first_row_time of UNION since the UNION rule dictates that EFT of UNION is EFT of the first leg of the UNION+the first_row_time of UNION.

Thus, repeating the use of the ETT and EFT computations for involved operators and the rules for operators, a complex plan can be traversed and the TUOS for the needed operators can be obtained.

The preceding calculation is used to calculate TUS and TUOS in steps 502 and 504 of FIG. 5 of the present invention. The gain due to sibling asynchrony for a particular SHIP/RPD operator is the smaller of TUS and TUOS, since that is the amount of time the SHIP/RPD operation could execute asynchronously. The resource consumption overhead of adding an ATQ operator is computed by the federated optimizer, in step 508 of FIG. 5. Before assigning an ATQ operator to a SHIP/RPD operation the sibling asynchrony, in steps 506 and 510 the algorithm, checks whether min(TUS, TUOS)−TQ overhead is >0, i.e. whether there will be some gain due to the sibling asynchrony. If this quantity is positive, the SHIP/RPD operator is tentatively marked eligible to receive an ATQ operator, pending confirmation by the following heuristic of FIG. 6.

FIG. 6 illustrates execution of an experiment-based heuristic to estimate whether making a remote query fragment asynchronous is likely to provide some benefit in terms of producer-consumer asynchrony and, if so, to deem that it is beneficial to place an ATQ operator above each such remote fragment having a SHIP/RPD operator.

Experiments were performed to understand the effect of introduction of ATQ operators on the producer-consumer asynchrony. The benefit of enabling asynchronous execution of a SHIP/RPD operator depends in part on the characteristics of the consuming operator above the SHIP/RPD operator. If the rate at which rows are consumed by that operator is well-matched with the rate at which rows are produced by the SHIP operator, some useful producer-consumer asynchrony can be achieved. The rate at which an operator consumes rows is influenced by the type of the operator and the operators above it. If the consuming operator is fast and spends most of its time waiting for the producer, there is little benefit and the extra overhead introduced by the ATQ operator may regress the query as a whole.

Because it is difficult to quantify the gain or loss incurred, a heuristic was developed on the basis of experimental evidence which showed that placement of an ATQ operator above a SHIP/RPD operator should be avoided in situations where the consumer is likely to be able to process rows much more quickly than the SHIP/RPD operator can deliver them. Experimental results indicate that it is always a good idea to enable asynchrony for SHIP/RPD operators whose binary/n-ary consumer is MGJN, UNION or NLJN. Each of these operators is sufficiently costly so that its rate of row consumption appears to compare reasonably with the rate of row production of the SHIP/RPD operator. Further, it was found that making SHIP/RPD operators below a HSJN (hash join) operator asynchronous is not always a good idea and can cause regressions because the hash join operator itself is comparatively lightweight, especially if many rows do not survive the join. If each of the operators above the hash join process rows as fast as the hash join itself, then that pipeline likely processes rows more quickly than the SHIP/RPD operator produces them and does not benefit from asynchrony. In this case, placement of an ATQ operator above the SHIP/RPD operator adds overhead that may slow the query down.

Accordingly, the heuristic of FIG. 6 seeks to identify hash join operators with one or more SHIP/RPD operator inputs and recommends placement of ATQ operators above those SHIP/RPD operators as follows. Step 602 determines whether a consumer of the SHIP/RPD operator is an HSJN operator. If so, SHIP/RPD is qualified to receive an ATQ operator, which is marked in step 610, and routine returns in step 604. Otherwise, step 606 determines whether the operator above the HSJN is a lightweight operator, such as a filtering, group-by, hash join or unique operator. If so, the heuristic concludes that there is no benefit in enabling asynchrony, marked appropriately in step 603, and returns in step 604. If the operator is not lightweight, step 608 determines whether a significant portion of rows survive the HSJN to reach the operators above it. If not, it is marked appropriately in step 603, and the routine returns in step 604. If the operators above the hash join are more substantial and a significant proportion of rows survive the hash join to reach the operators above it, the heuristic concludes that the addition of an ATQ operator above the SHIP/RPD operator is worthwhile with respect to enabling producer-consumer asynchrony and will likely result in a performance improvement, which is marked in step 610, and the routine returns in step 604.

Once the list of all eligible SHIP/RPD operators has been created, in step 212 of the preferred embodiment shown in FIG. 2, the system automatically allocates an ATQ operator to each eligible SHIP/RPD operator.

Alternatively, another aspect of the present invention, shown in FIG. 3, can be used for automated allocation of ATQ operators, and it encompasses the described basic algorithm illustrated in FIG. 2. This aspect of the present invention is called an extended benefit/cost analysis algorithm, also named an optional distribution algorithm, that can be run to optimally distribute a limited number of ATQ operators over SHIP/RPD operators in a query execution plan. This method also provides a way for the user to optionally specify limits on the number of ATQ operators that can be placed in an execution plan by providing an algorithm to distribute the available ATQ operators over eligible SHIP/RPD operators in the query plan so that the elapsed time reduction is maximized. Thus, once eligibility for each remote fragment has been determined, the optional distribution algorithm of FIG. 3 decides which remote fragments should actually receive an ATQ operator, while staying within a per-query ATQ operator number limit and per-server ATQ operator number limit, in order to conserve system resources on both the federated server and on remote servers. The algorithm chooses a subset of SHIP/RPD operators so that making these SHIP/RPD operators asynchronous would result in maximal gain.

When an ATQ operator is used in a plan to achieve asynchronous execution, the asynchrony is achieved at the cost of some resources on the federated server. Typically, use of each ATQ operator results in consumption of one new process/thread and memory in the system. Thus, users may wish to limit the number of ATQ operators that can be placed into a query execution plan to take the resource constraints on their federated server into account. Users may also wish to limit the number of ATQ operators placed over SHIP/RPD operators that reference a particular remote server. If multiple SHIP/RPD operators execute their respective remote fragments on the same data source asynchronously, the data source will receive multiple concurrent requests for query execution in a given period of time. In the absence of asynchronous execution, these fragments would have been executed sequentially. With asynchronous execution users may want to limit the overlap in the processing of remote query fragments on a given server because they may not want to overload the data source or other applications running on the data source with strict response time requirements.

Because the asynchronous execution of remote query fragments obtained by placing ATQ operators above SHIP/RPD operators will typically lead to increased resource consumption both locally on the federated server and on the remote sources accessed by it, users may wish to specify two kinds of limits on the number of SHIP/RPD operators that may get an ATQ operator: a total upper limit on how many ATQ operators can be used for a given query in a federated system and a limit on how many ATQ operators can be used for SHIP/RPD operators belonging to a server. The optimizer may choose to use fewer ATQ operators than allowed by the defined limits depending on the cost/benefits analysis, but it may not use more.

FIG. 3 illustrates the steps of the algorithm that distributes ATQ operators within a query to maximize the benefit obtained by making eligible SHIP/RPD operators asynchronous, while respecting the per-query and per-server limits on ATQ operators. The maximum total number of ATQ operators that can be placed in a single federated query is called total_atqs. The limit for each server defines the maximum number of ATQ operators that can be placed over SHIP/RPD operators that reference this server in a single federated query is called total_atqs_for_server.

Step 302 of the extended advanced cost/benefit analysis utility, according to the preferred embodiments of the present invention, uses the basic advanced cost/benefit analysis utility algorithm, described in reference to FIGS. 2, 4, 5 and 6, to receive the list of all eligible SHIP/RPD operators obtained using the sibling asynchrony and producer-consumer asynchrony algorithms described above to identify the set of SHIP/RPD operators that, when enabled to execute asynchronously by adding an ATQ operator, would improve query performance. The reduction in elapsed time obtained by making a particular SHIP/RPD operator asynchronous is called the time gain. The algorithm achieves optimal distribution of the available, limited ATQ operators placed over the SHIP/RPD operators in a given query, so that the placement of each ATQ operator maximizes the elapsed time benefit due to asynchronous execution of those SHIP/RPD operators. The goal of the algorithm is to distribute ATQ operators among SHIP/RPD operators so that the performance of the query is maximized by minimizing the elapsed time while ensuring that none of the limits are violated.

Step 302 also creates an ordered list of all SHIP/RPD operators in the query execution plan that have a positive gain, sorted in decreasing order of time gain. Step 304 selects the top element of the list. Step 306 tentatively assigns an ATQ operator to the selected list element. Step 308 checks whether the total_atqs query limit has been reached. If so, the method continues with step 322. Otherwise, step 310 checks whether the total_atqs_for_server limit has been reached for the server used by this SHIP/RPD operator. If the total_atqs_for_server limit has been met for some remote server the algorithm will no longer consider adding more ATQ operators to SHIP/RPD operators that belong to that server. However, SHIP/RPD operators for that server with assigned ATQ operators are still subject to the recomputation of benefit described below, and as such, their ATQ operators could conceivably be taken away and made available to other SHIP/RPD operators.

Thus, if the total_atqs_for_server limit has been met for a remote server, the method continues with step 312 to determine whether it is the last list element and, if not, returns to execute step 304. If the end of list is reached, step 322 permanently assigns ATQ operators to the SHIP/RPD operators with tentative ATQ operator assignment and routine stops execution in step 324. If neither limit is reached, the tentative placement remains. Thus, if it is determined in step 310 that ATQ server limit has not been reached for this server, step 314 removes the SHIP/RPD operator under consideration from the list, awaiting possible ATQ assignment. Step 316 recomputes the gain for all other SHIP/RPD operators in the query, including list elements with tentative ATQ operator assignments, after taking into account the overlap achieved by assigning an ATQ operator to the current SHIP/RPD operator. Step 318 removes non-beneficial list elements and resorts the remaining list elements in decreasing gain order. Step 320 then adjusts all ATQ query and server limits and method continues with step 312.

Thus, the algorithm terminates under one of three conditions: all SHIP/RPD operators in the ordered sequence have been assigned an ATQ operator, the maximum number of ATQ operators per server, total_atqs_for_server, has been assigned to SHIP/RPD operators belonging to those servers, i.e., the per server limit of ATQ operators has been reached for all the servers, or the limit for the total number of ATQ operators for the query, total_atqs, has been reached.

### B. NON-FEDERATED PREFERRED EMBODIMENTS

The non-federated preferred embodiments of the present invention are directed to a system, method and program storage device embodying a program of instructions executable by a computer to perform the method of the present invention for advanced cost/benefit analysis of subplans of a query execution plan, in a computer system having a non-federated database software server. The method augments a cost estimation model, obtained from a conventional optimizer of the software server in a relational DBMS, after determination of an optimal query execution plan, with an advanced cost/benefit analysis of operating each subplan of the query execution plan asynchronously. It calculates a subplan elapsed time benefit of making the subplan asynchronous using a set of cost estimates for each subplan operation and knowledge of the execution sequence of the query execution plan operations, all provided by the query optimizer, as described above for the federated embodiments.

The non-federated preferred embodiments of the present invention are illustrated in FIGS. 8-12, corresponding to FIGS. 1-5, respectively. FIG. 8 illustrates an exemplary computer hardware and software environment usable by the non-federated preferred embodiments of the present invention, running on multiprocessor systems, to enable the advanced cost/benefit analysis method of the present invention. FIG. 8 includes a software server 1102 having a plurality of conventional processors 1103. Software server 1102 has access to an advanced cost/benefit analysis utility 1114 of the present invention and an optimizer 1108, in addition to a local data source DBMS 1112 and databases on multiple data storage devices 1104, 1106.

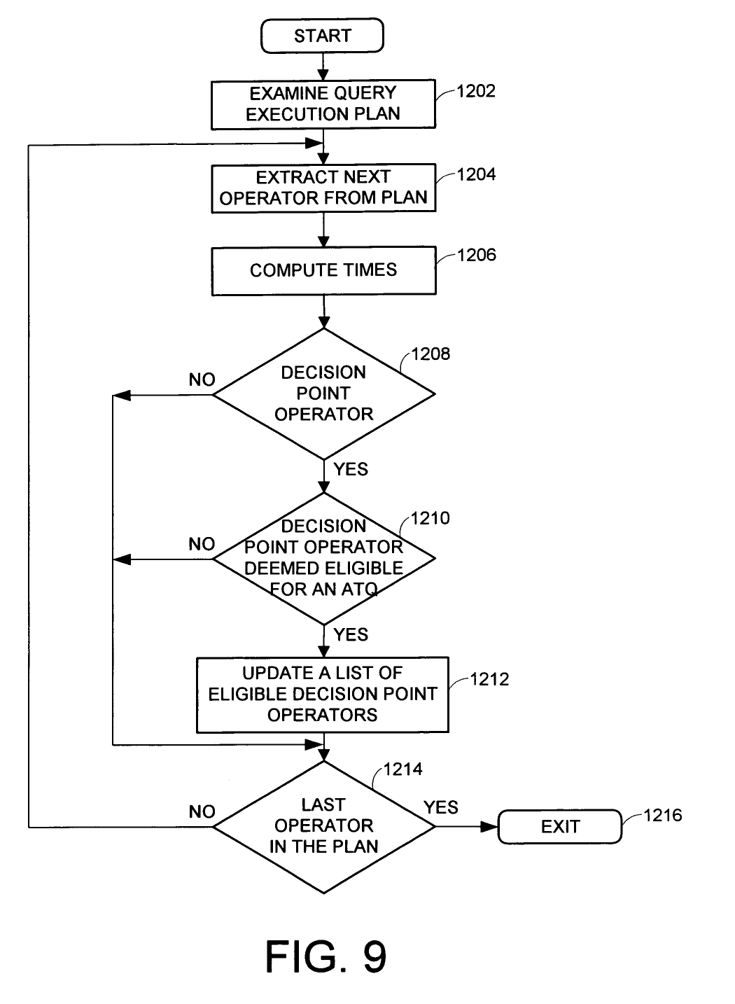

Flowcharts of FIGS. 9-12 are almost identical to flowcharts of FIGS. 2-5, showing that the methods of the federated preferred embodiments of the present invention can be applied to a non-federated DBMS running in a multiprocessor system, performing a similar cost/benefit analysis made to determine the effect of one or more portions of a query, named subplans, asynchronously executed in the same DBMS, because the non-federated embodiments do not involve access to a plurality of data sources.

Software server 1102, running on a multiprocessor computer system, uses a special ATQ operator to cause subplans of a single query in a DBMS to be executed asynchronously. A subplan is a set of query plan operators in the query execution plan that are located below a particular operator under consideration, named a decision point operator in the non-federated embodiments, which is a point at which asynchrony could be introduced. Thus, a subplan is the generalization of the remote query fragment of the federated embodiments and the decision point operator is the generalization of the SHIP/RPD operator of the federated embodiments. However, any operator in the non-federated environment can be a decision point whereas the federated embodiments are limited to SHIP and RPD operators.

The subplan below a particular decision point operator is made asynchronous by placing an ATQ operator in the query plan, above the decision point. In the non-federated environment there are many more types of eligible subplans because there are more decision point types to be evaluated. Eligible subplans are defined as any branch or part of the branch of the query execution plan and may include leaf level operators, such as a full table scan and index scan, a table access followed by a sort operation, a branch of the plan that includes a JOIN operator and its legs, individual legs of UNION operators, etc.

FIG. 9 illustrates a flowchart of the basic advanced cost/benefit analysis utility 1114 algorithm, according to the preferred non-federated embodiments of the present invention, which uses the algorithm described above for the federated environment.

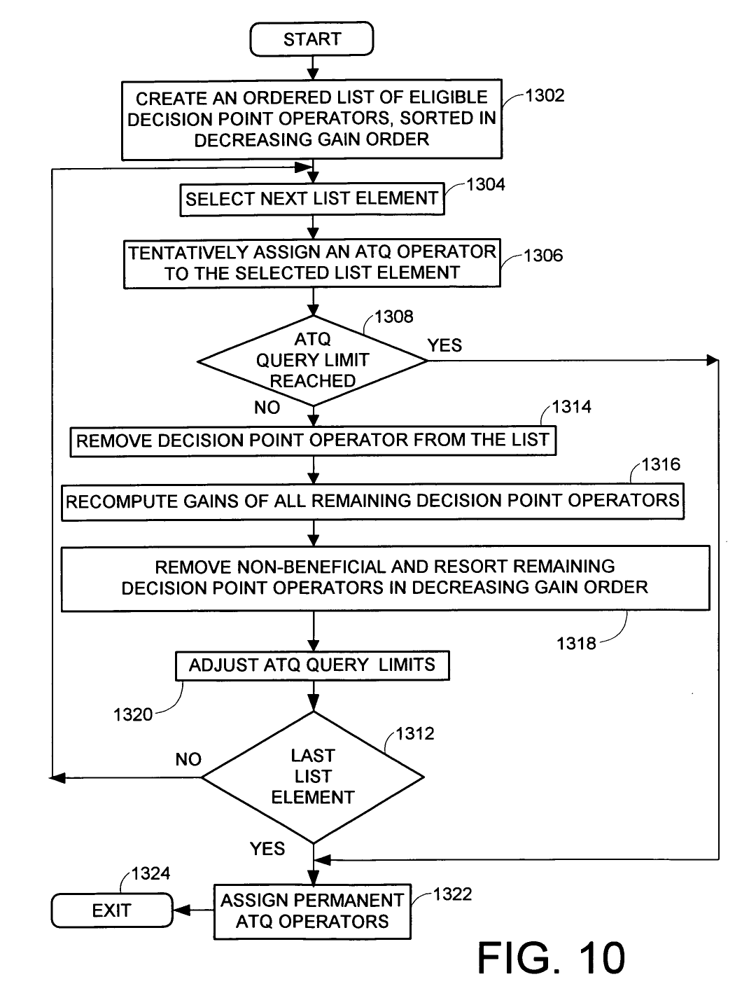

FIG. 10 illustrates a flowchart of the extended advanced cost/benefit analysis utility algorithm, according to the preferred non-federated embodiments of the present invention, which uses the algorithm described above for the federated environment. However, there is no step 310 in FIG. 10, because there are no remote servers in the non-federated environment, and there is only one type of resource constraint to be tested, the total number of ATQ operators allowed per query.

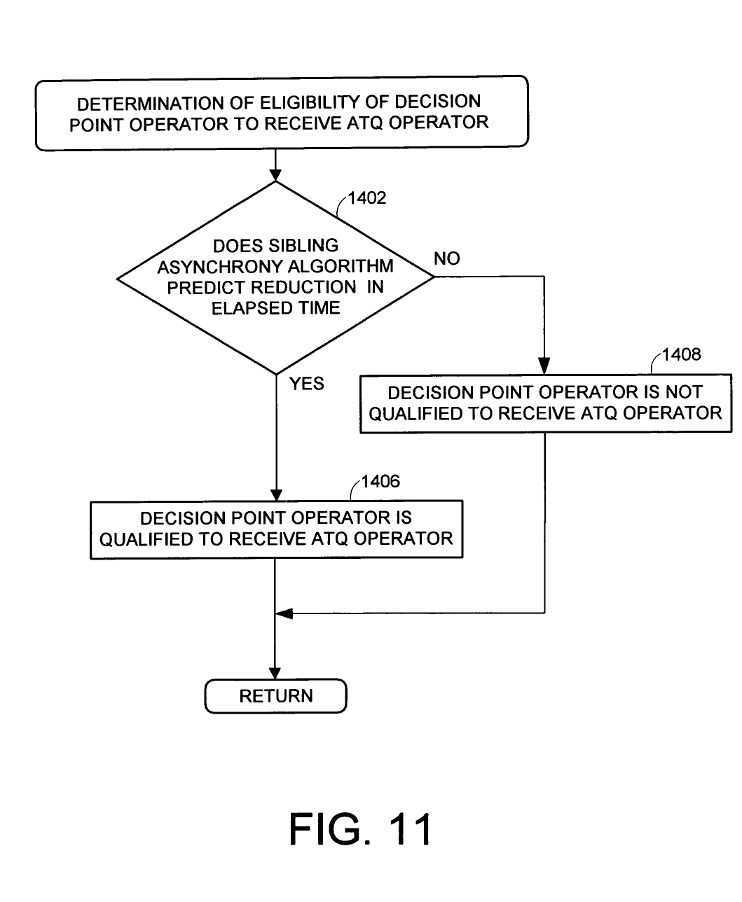

FIG. 11 illustrates a flowchart of the method used to determine whether a decision point operator is eligible for an ATQ operator, according to the preferred non-federated embodiments of the present invention, which uses the algorithm described above for the federated environment. However, there is no step 404 in FIG. 11 because the producer-consumer asynchrony heuristic would need to be established, using experimentation, on the system where it will be implemented.

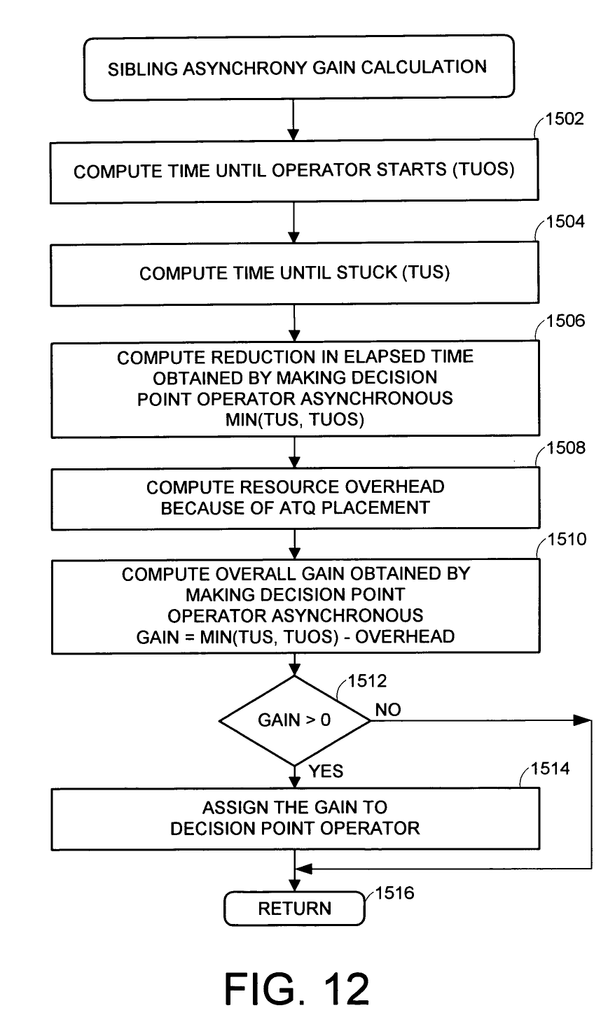

FIG. 12 illustrates a flowchart of the method used to predict whether use of sibling asynchrony will reduce elapsed time, if the decision point operator is made asynchronous, according to the preferred non-federated embodiments of the present invention. The sibling asynchrony algorithm evaluates the reduction in elapsed time achieved by adding an ATQ operator above various decision points in order to make the subplan below the decision point asynchronous, using the algorithm described above for the federated environment.

The foregoing description of the preferred embodiments of the present invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for performing advanced cost/benefit analysis of subplans of a query execution plan, in a computer system having a database software server, comprising:
(a) augmenting a cost estimation model, obtained from an optimizer of the software server after determination of an optimal query execution plan, with a cost/benefit analysis of operating each subplan of the query execution plan asynchronously.

2. The method according to claim 1, wherein a subplan elapsed time benefit of making the subplan asynchronous is determined using a set of cost estimates for each subplan operation and knowledge of the execution sequence of the query execution plan operations, all provided by the query optimizer.

3. The method according to claim 2, further comprising a step of using the augmented cost model for determining a set of subplans that are eligible for asynchronous operations reducing the total query elapsed time.

4. The method according to claim 3, wherein the augmented cost model utilizes a sibling asynchrony algorithm to predict whether an overhead associated with executing the subplan asynchronously outweighs the performance benefit of the asynchrony itself.

5. The method according to claim 3, wherein the set of subplans for asynchronous execution is chosen to form an optimal set of subplans while respecting a resource constraint, for providing a maximal reduction of the total query elapsed time while conserving system resources of the software server, and wherein the set of subplans is built by adding each subplan according to the subplan elapsed time benefit, in decreasing order, until a per-query limit defining a number of asynchronous subplans is reached.

6. The method according to claim 3, wherein the software server is a federated software server providing connectivity to a plurality of databases, and wherein a subset of the set of subplans is executed asynchronously on a plurality of remote databases, concurrently and independently of other subplans.

7. The method according to claim 6, wherein the subset of the set of subplans executed asynchronously on remote databases is built by adding each subplan according to the subplan elapsed time benefit, in decreasing order, until a limit is reached, wherein the limit is chosen from a group comprising a per-query limit defining a number of asynchronous subplans and a per-remote-database limit defining a number of subplans using a remote database.

8. The method according to claim 7, wherein the augmented cost model utilizes a sibling asynchrony algorithm to predict whether an overhead associated with executing the subplan asynchronously outweighs the performance benefit of the asynchrony itself and a producer-consumer asynchrony heuristic to predict whether a producer speed and a consumer speed are well matched to obtain a beneficial asynchronous operation.

9. The method according to claim 8, wherein the federated software server is connected to a plurality of data sources providing access to multiple databases, physically distributed and disparate DBMSs, residing on different hardware systems and possibly storing data in different formats.

10. The method according to claim 1, wherein the method is implemented as a portable utility comprising an add-on to the DBMS query optimizer.

11. A system for performing advanced cost/benefit analysis of subplans of a query execution plan, in a computer system having a database software server, comprising:
means for augmenting a cost estimation model, obtained from an optimizer of the software server after determination of an optimal query execution plan, with a cost/benefit analysis of operating each subplan of the query execution plan asynchronously.

12. The system according to claim 11, wherein a subplan elapsed time benefit of making the subplan asynchronous is determined using a set of cost estimates for each subplan operation and knowledge of the execution sequence of the query execution plan operations, all provided by the query optimizer.

13. The system according to claim 12, further comprising means of using the augmented cost model for determining a set of subplans that are eligible for asynchronous operations reducing the total query elapsed time.

14. The system according to claim 13, wherein the augmented cost model utilizes a sibling asynchrony algorithm to predict whether an overhead associated with executing the subplan asynchronously outweighs the performance benefit of the asynchrony itself.

15. The system according to claim 13, wherein the set of subplans for asynchronous execution is chosen to form an optimal set of subplans while respecting a resource constraint, for providing a maximal reduction of the total query elapsed time while conserving system resources of the software server, and wherein the set of subplans is built by adding each subplan according to the subplan elapsed time benefit, in decreasing order, until a per-query limit defining a number of asynchronous subplans is reached.

16. The system according to claim 13, wherein the software server is a federated software server providing connectivity to a plurality of databases, and wherein a subset of the set of subplans is executed asynchronously on a plurality of remote databases, concurrently and independently of other subplans.

17. The system according to claim 16, wherein the subset of the set of subplans executed asynchronously on remote databases is built by adding each subplan according to the subplan elapsed time benefit, in decreasing order, until a limit is reached, wherein the limit is chosen from a group comprising a per-query limit defining a number of asynchronous subplans and a per-remote-database limit defining a number of subplans using a remote database.

18. The system according to claim 17, wherein the augmented cost model utilizes a sibling asynchrony algorithm to predict whether an overhead associated with executing the subplan asynchronously outweighs the performance benefit of the asynchrony itself and a producer-consumer asynchrony heuristic to predict whether a producer speed and a consumer speed are well matched to obtain a beneficial asynchronous operation.

19. The system according to claim 18, wherein the federated software server is connected to a plurality of data sources providing access to multiple databases, physically distributed and disparate DBMSs, residing on different hardware systems and possibly storing data in different formats.

20. The system according to claim 11, wherein the system is portable and comprises an add-on to the DBMS query optimizer.

21. A computer usable medium tangibly embodying a program of instructions executable by the computer to perform method steps for performing advanced cost/benefit analysis of subplans of a query execution plan, in a computer system having a database software server, comprising:
(a) augmenting a cost estimation model, obtained from an optimizer of the software server after determination of an optimal query execution plan, with a cost/benefit analysis of operating each subplan of the query execution plan asynchronously.

22. The method according to claim 21, wherein a subplan elapsed time benefit of making the subplan asynchronous is determined using a set of cost estimates for each subplan operation and knowledge of the execution sequence of the query execution plan operations, all provided by the query optimizer.

23. The method according to claim 22, further comprising a step of using the augmented cost model for determining a set of subplans that are eligible for asynchronous operations reducing the total query elapsed time.

24. The method according to claim 23, wherein the augmented cost model utilizes a sibling asynchrony algorithm to predict whether an overhead associated with executing the subplan asynchronously outweighs the performance benefit of the asynchrony itself.

25. The method according to claim 23, wherein the set of subplans for asynchronous execution is chosen to form an optimal set of subplans while respecting a resource constraint, for providing a maximal reduction of the total query elapsed time while conserving system resources of the software server, and wherein the set of subplans is built by adding each subplan according to the subplan elapsed time benefit, in decreasing order, until a per-query limit defining a number of asynchronous subplans is reached.

26. The method according to claim 23, wherein the software server is a federated software server providing connectivity to a plurality of databases, and wherein a subset of the set of subplans is executed asynchronously on a plurality of remote databases, concurrently and independently of other subplans.

27. The method according to claim 26, wherein the subset of the set of subplans executed asynchronously on remote databases is built by adding each subplan according to the subplan elapsed time benefit, in decreasing order, until a limit is reached, wherein the limit is chosen from a group comprising a per-query limit defining a number of asynchronous subplans and a per-remote-database limit defining a number of subplans using a remote database.

28. The method according to claim 27, wherein the augmented cost model utilizes a sibling asynchrony algorithm to predict whether an overhead associated with executing the subplan asynchronously outweighs the performance benefit of the asynchrony itself and a producer-consumer asynchrony heuristic to predict whether a producer speed and a consumer speed are well matched to obtain a beneficial asynchronous operation.

29. The method according to claim 28, wherein the federated software server is connected to a plurality of data sources providing access to multiple databases, physically distributed and disparate DBMSs, residing on different hardware systems and possibly storing data in different formats.

30. The method according to claim 21, wherein the method is implemented as a portable utility comprising an add-on to the DBMS query optimizer.
